(19) United States
(12) Patent Application Publication
(10) Pub. No.: US 2017/0161553 A1
(43) Pub. Date: Jun. 8, 2017

(54) METHOD AND ELECTRONIC DEVICE FOR CAPTURING PHOTO

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Wenfeng WANG, Beijing (CN)

(21) Appl. No.: 15/244,509

(22) Filed: Aug. 23, 2016

Related U.S. Application Data
(63) Continuation of application No. PCT/CN2016/088969, filed on Jul. 6, 2016.

(30) Foreign Application Priority Data
Dec. 8, 2015 (CN) 201510898441.2

(51) Int. Cl. G06K 9/00; H04N 5/232

(52) U.S. Cl. CPC G06K 9/00302; H04N 5/23293; G06K 9/00228; G06K 9/00281

(57) ABSTRACT

A method and an electronic device for capturing photo are disclosed by the present disclosure. The method includes: generating preview images by obtaining shooting scene in real time utilizing a camera; determining a five-sense-organ characteristic value of a human face image in each frame of the preview image; and photographing the shooting scene to obtain a five-sense-organ image when the five-sense-organ characteristic value meets a preset capturing condition.

### CROSS-REFERENCE TO RELATED APPLICATIONS

This application is a continuation application of a PCT application No. PCT/CN2016/088969, filed on Jul. 6, 2016; and claims the priority of Chinese Patent Application No. 201510898441.2, titled “Method and Electronic Device for capturing photo”, filed to the State Intellectual Property Office of China (SIPO) on Dec. 8, 2015, the entire content of which is incorporated hereby by reference.

### TECHNICAL FIELD

Embodiments of the present disclosure relate to intelligent terminal technologies, for example, relate to a method and an electronic device for capturing photo.

### BACKGROUND

In daily life, it is more and more common for people to utilize intelligent terminals (such as smartphones or tablets) to capture photos, and the capturing functions of intelligent terminals are more and more improved.

At present, when a user takes a photograph, people are generally the main subjects of the captured images, and the capturing images are directly affected by expressions of the people. The inventors have found that user generally cannot exactly seize the moment during when people have their best expression while taking a photograph, so the results often do not meet the requirements of the user. For example, when photographing a smiling person, the user often cannot determine a moment of a best smile, which may result in multiple photographs being taken. In particular, when photographing smiles of a baby, there is a problem associated with frequently failing to exactly seize a moment of a best smile of a baby since it is hard to foresee the moment of a best smile of a baby. Sometimes, the user has to repeatedly photograph many times and select a most satisfying one from captured photos so as to obtain a best captured photo, so that time cost of photographing is increased, and user experience is bad.

### SUMMARY

The present disclosure provides a method and an electronic device for capturing image. According to the method and electronic device, and an image is obtained.

According to a first aspect, the method for capturing image provided by embodiments of the present disclosure includes:
obtaining a shooting scene in real time by a camera so as to generate a preview image;
determining a five-sense-organ characteristic value of a human face image in each frame of the preview image; and
photographing the shooting scene when the five-sense-organ characteristic value meets a set capturing condition, so as to obtain a final image.

According to a second aspect, embodiments of the present disclosure provide an electronic device for capturing photo. The electronic device includes: at least one processor and a memory. Instructions executable by the at least one processor may be stored in the memory. Execution of the instructions by the at least one processor causes the at least one processor to:
obtain a shooting scene in real time by a camera so as to generate a preview image;
determine a five-sense-organ characteristic value of a human face image in each frame of the preview image; and
photograph the shooting scene when the five-sense-organ characteristic value meets a set capturing condition, so as to obtain a final image.

According to a third aspect, embodiments of the present disclosure provide a non-transitory memory storage medium, storing executable instructions that, when executed by an electronic device, cause the electronic device to: obtain a shooting scene in real time by a camera so as to generate a preview image;
determine a five-sense-organ characteristic value of a human face image in each frame of the preview image; and
photograph the shooting scene when the five-sense-organ characteristic value meets a set capturing condition, so as to obtain a final image.

### BRIEF DESCRIPTION OF THE DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for capturing photo according to embodiments of the present disclosure;

FIG. 2 is a flowchart illustrating a method for capturing photo according to embodiments of the present disclosure;

FIG. 3 is a flowchart illustrating a method for capturing photo according to embodiments of the present disclosure;

FIG. 4 is a schematic structural diagram illustrating a device for capturing photo according to embodiments of the present disclosure; and

FIG. 5 is a schematic diagram illustrating a hardware structure of an electronic device according to embodiments of the present disclosure.

### DETAILED DESCRIPTION

The present disclosure will be further described in detail below in conjunction with accompanying drawings and embodiments. It should be understood that the embodiments described herein are merely used for explaining the present disclosure, but not limiting the present disclosure. In addition, it is also noted that, for easy of description, relevant parts, rather than all parts, related to the present disclosure are shown in the accompanying drawings.

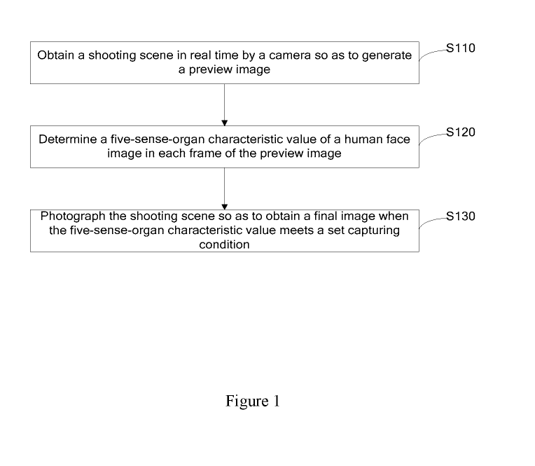

FIG. 1 is a flowchart illustrating a method for capturing photo according to embodiments of the present disclosure. The present embodiment can be applied to a case of capturing a photo showing a best moment of smiles of people. The method can be executed by an intelligent terminal, which is provided with a device for capturing a photo showing a best moment of smiles of people. The method includes: step 110, step 120 and step 130.

In step 110, a shooting scene is obtained in real time by a camera so as to generate a preview image.

A user selects a shooting scene, and points the camera of the intelligent terminal to the shooting scene. Based on optical imaging principles, the shooting scene will be imaged on photosensitive elements in the camera through lens of the camera. The photosensitive elements convert optical signals into electrical signals and send the electrical signals to a controller in the intelligent terminal. The preview image of the shooting scene is generated by the controller, and is displayed by controlling a display screen of the intelligent terminal. Since people and/or objects in the shooting scene selected by the user are not at a static state, the intelligent terminal acquires the shooting scene in real time according to a set frequency so as to generate and display the preview image, rather than merely acquires one frame of image of the shooting scene.

In step 120, a five-sense-organ characteristic value of a human face image in each frame of the preview image is determined.

The five-sense-organ characteristic value may include an eyebrow motion characteristic value, an eye motion characteristic value, a lip motion characteristic value or the like. Emotions of people can be represented by facial characteristics, so that emotion conditions of people can be represented by set values of the five-sense-organ characteristic value. For example, smile can be represented by rising mouth corners, opening the mouth and/or shrinking eyes and the like, and anger can be represented by sagging mouth corners, closing the mouth and/or opening eyes widely and the like.

The intelligent terminal performs human face recognition to each frame of the preview image to determine whether a human face is included in the preview image, and determines a location of the human face if the human face is included in the preview image. The intelligent terminal determines a lip profile in each frame of the preview image which includes a human face according to an image processing algorithm, and determines a lip motion characteristic value based on the lip profile. The intelligent terminal may also determine an eye profile in each frame of the preview image which includes a human face according to the image processing algorithm, and determine an eye motion characteristic value based on the eye profile.

In step 130, the shooting scene is photographed when the five-sense-organ characteristic value meets a set capturing condition, so as to obtain a final image.

The capturing condition may be a data statistic value of the five-sense-organ characteristic values corresponding to an emotion that the user wants to photograph. The data statistic values of five-sense-organ characteristic values corresponding to different emotions of people may be obtained by counting and concluding mass of expression data of people. In application, the capturing condition may be set as a five-sense-organ characteristic value at a moment when an emotion of people just appeared on face. For example, a lip motion characteristic value corresponding to a moment when the user begins to smile is set as a capturing condition for starting photographing.

The intelligent terminal matches the five-sense-organ characteristic value to the set capturing condition. When the five-sense-organ characteristic value meets the set capturing condition, the shooting scene is continuously shot to obtain a preset frame numbers of continuously shot images in a preset period of time, and an image having a maximum expression characteristic value in the continuously shot images is determined as the final image. For example, when the user wants to capture a photo showing a best moment of smiles of people, the camera is pointed to people by using the method of the present embodiment, so that the camera automatically focuses on face of the people and acquires a lip motion characteristic value of the people to match with the set capturing condition. It is judged whether the lip motion characteristic value exceeds the set capturing condition if the preset capturing condition is the lip motion characteristic value corresponding to a moment just when the user begins to smile, and a continuous shooting function is activated to continuously shoot the people for 1 minute so as to obtain a plurality of images of the people if the lip motion characteristic value exceeds the set capturing condition. The intelligent terminal determines expression characteristic values of the people in the captured plurality of images of the people according to the lip motion characteristic value, and takes an image having a maximum expression characteristic value in the plurality of images of the people as the final image. The intelligent terminal saves the final image and deletes the rest of images in the continuously shot images. Since the expression characteristic value of the final image is maximum, expressional capturing effect of this frame of image is the best, deleting of the rest images can avoid a problem that storage space is reduced due to occupation of the storage space by images with bad capturing effects.

According to technical solutions of the present embodiment, a shooting scene is obtained in real time by a camera so as to generate a preview image; a five-sense-organ characteristic value of a human face image in each frame of the preview image is determined; and the shooting scene is photographed when the five-sense-organ characteristic value meets a set capturing condition, so as to obtain a final image. Technical solutions of the present embodiment solve a problem that a good opportunity for shooting is missed since a best moment for expressions of people is unable to foresee; achieve a purpose to automatically recognize expressions of people to shoot so as to obtain a photo with a best expression; and achieve effects of improving capturing efficiency and application experience of users.

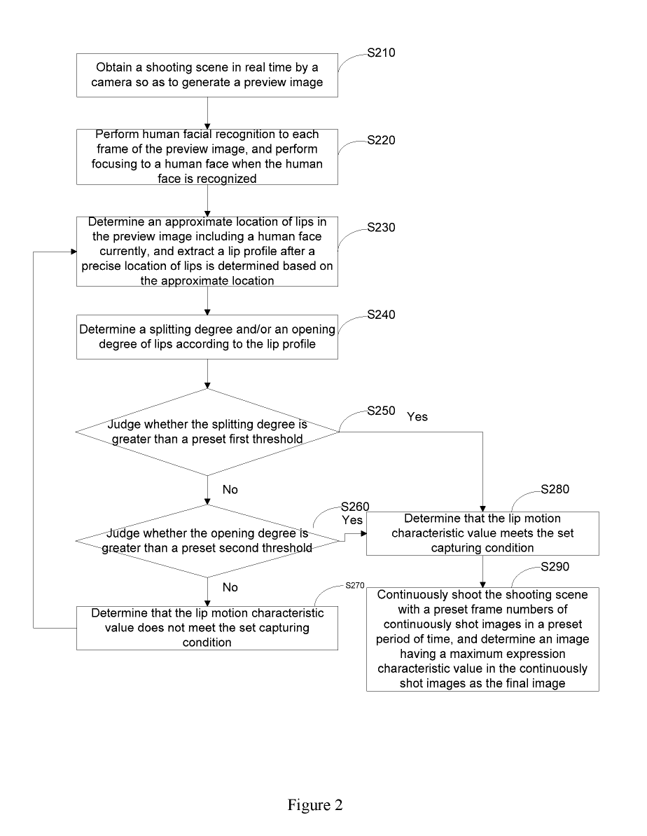

FIG. 2 is a flowchart illustrating a method for capturing photo according to embodiments of the present disclosure. The method for capturing photo of the present embodiment includes: step 210-step 290.

In step 210, a shooting scene is obtained in real time by a camera so as to generate a preview image.

The user points the camera to the shooting scene and activates the capturing function of the present embodiment. The intelligent terminal obtains the shooting scene in real time by the camera so as to generate preview images, and the preview images are displayed by a display screen. For example, when the user wants to capture smiles of baby, the user can point the camera of the intelligent terminal to the baby and activates the capturing function of the present embodiment. The intelligent terminal activates corresponding functions according to an instruction for activating the capturing function of the present embodiment input by the user, obtains images of the baby in real time by the camera according to a preset frequency, generates preview images and displays the preview images on the display screen.

In step 220, human facial recognition is performed to each frame of the preview image, and focusing is performed to a human face when the human face is recognized.

The intelligent terminal performs human facial recognition to each frame of the preview image, deletes data associated with the preview image if no human face is included in the preview image, and positions a location of the human face and performs focusing to the human face if the human face is included in a preview image. For example, after acquiring preview images including the baby, the intelligent terminal performs facial recognition to the preview images, and selects preview images including facial information of the baby form the preview images. Since it is required to obtain lip motion characteristic values, the preview images including facial information of the baby for example are preview images with clear and compete lip profiles. When face of the baby is recognized, the intelligent terminal controls the camera to focus on the face so as to obtain clear information about the face.

In step 230, an approximate location of lips in the preview image including a human face currently is determined, and a lip profile is extracted after a precise location of lips is determined based on the approximate location.

The intelligent terminal sequentially acquires one frame of image in the preview image including a human face as a current preview image, and determines a human face region in the current preview image. After the human face region is detected, the intelligent terminal performs lip approximate positioning according to human face geometrical features. By analyzing mass data about human facial information, a lip region may be delimited within one third of a human face from the button, and a distance between the lip region and right and left borders of the human face is within one fourth of a width of the human face. There are a number of ways to extract lip information from facial information, and one optional method is merely illustrated in the present embodiment, so that it is not limited that only the method is adopted in the present embodiment. The intelligent terminal further processes the lip region using an image processing algorithm so as to determine the precise location of lips. For example, a Fisher transformation can be performed to the preview image so as to distinguish a skin color region and a lip color region, so that the precise location of lips is obtained. Next, lip information and mouth information are distinguished based on brightness information of the preview image, and the mouth information is filtered out so as to avoid influence of the mouth information on lip profile determination. Finally, a binarisation process is performed to a processed image, and lip profile information is obtained by performing gray projection to a binarisation result.

In step 240, a splitting degree and/or an opening degree of lips is determined according to the lip profile.

On a basis of lip segmentation and positioning, the intelligent terminal can acquire left and right mouth corners by vertical projecting, and acquire an upmost point on center of upper lip, a down most point on center of upper lip, an upmost point on center of lower lip and a down most point on center of lower lip by horizontal projecting. Through calculation on coordinates of the left and right mouth corners, the upmost point on center of upper lip, the down most point on center of upper lip, the upmost point on center of lower lip and the down most point on center of lower lip, the splitting degree and the opening degree of lips can be determined.

In step 250, it is judged whether the splitting degree is greater than a preset first threshold. If the splitting degree is greater than the preset first threshold, step 280 is executed; and, if the splitting degree is not greater than the preset first threshold, step 260 is executed.

A splitting degree of lips at a moment when people begins to smile is regarded as the preset first threshold. The splitting degree of lips at the moment when people begins to smile can be obtained by counting mass facial expressions when people smiles based on statistical principles. The splitting degree of lips of people included in the preview image is compared with the preset first threshold, if the splitting degree is greater than the first threshold, it is identified that people begins to smile and step 280 is executed; and, if the splitting degree is less than the preset first threshold, step 260 is executed.

In step 260, it is judged whether the opening degree is greater than a preset second threshold. If the opening degree is greater than the preset second threshold, step 280 is executed; and, if the opening degree is not greater than the preset second threshold, step 270 is executed.

An opening degree of lips at a moment when people begins to smile is regarded as the preset second threshold. The opening degree of lips at the moment when people begins to smile can also be obtained by counting mass facial expressions when people smiles based on statistical principles. The opening degree of lips of people included in the preview image is compared with the preset second threshold when the splitting degree of lips of people included in the preview image is less than the preset first threshold. If the opening degree is greater than the preset second threshold, it can also be identified that people begins to smile and step 280 is executed; and, if the opening degree is less than the preset second threshold, step 270 is executed.

In step 270, it is determined that the lip motion characteristic value does not meet the set capturing condition.

For example, when photographing smiles of a baby, the user determines through the intelligent terminal that a splitting degree of lips included in the current preview image is less than the preset first threshold, and the opening degree of lips is less than the preset second threshold. It means that the baby does not begin to smile, and a current lip motion characteristic value does not meet a set capturing condition for photographing smiles of people, so that information of the current preview image is deleted, and the method is returned to execute step 230, so as to re-judge by regarding a preview image at a next frame as a current preview image.

In step 280, it is determined that the lip motion characteristic value meets the set capturing condition.

For example, when photographing smiles of a baby, the user determines through the intelligent terminal that a splitting degree included in the current preview image is greater than the preset first threshold. It means that the baby begins to smile, that is, the lip motion characteristic value meets the set capturing condition, so that photographing can be started. If it is determined through the intelligent terminal that the splitting degree of lips included in the current preview image is less than the preset first threshold, then it is judged whether an opening degree of lips included in the preview image is greater than the preset second threshold, and it also means that the baby begins to smile if the opening degree is greater than the preset second threshold, that is, the lip motion characteristic value meets the set capturing condition, so that photographing can be started.

In step 290, the shooting scene is continuously shot with a preset frame numbers of continuously shot images in a preset period of time, and an image having a maximum expression characteristic value in the continuously shot images is determined as the final image.

The intelligent terminal sets the preview image that meets the set capturing condition as a photographing beginning, and continuously shoots for the set period of time (a duration of the continuous shooting may be 1 minute) so as to obtain the preset frame numbers of continuously shot images. For example, the intelligent terminal is configured that 9 photos of the shooting scene can be obtained by continuously shooting for 1 minute when a continuous photographing mode is activated. A weighted sum of a splitting degree and an opening degree in each frame of image in the continuously shot images is calculated, so as to obtain an expression characteristic value; and, expression characteristic values of the continuously shot images are compared to determine a frame of image corresponding to a maximum expression characteristic value as the final image. The intelligent terminal can determine the expression characteristic value by means of calculating a sum of a product of the splitting degree and a weighting factor set for the splitting degree, and a product of the opening degree and a weighting factor set for the opening degree. For example, when determining a smile characteristic value, a smile characteristic value can be determined by means of calculating a sum of a product of the splitting degree of lips and 80% (weighting factor), and a product of the opening degree and 20% (weighting factor). The intelligent terminal calculates a smile characteristic value of each frame of the preview image including a human face respectively, compares smile characteristic values obtained by calculating, and selects the preview image corresponding to the maximum smile characteristic value as the final image.

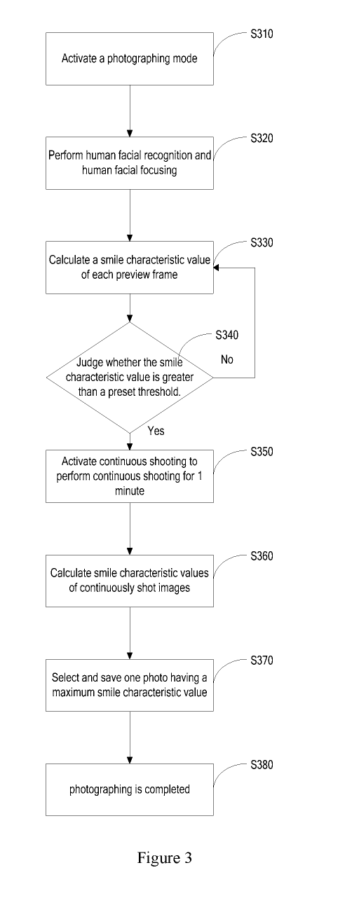

FIG. 3 is a flowchart illustrating a method for capturing photo according to embodiments of the present disclosure. The method for capturing photo of the present embodiment includes step 310 to step 380.

In step 310, a photographing mode is activated.

The user points the camera at the shooting scene and activates a capturing mode of the present embodiment. For example, the user wants to photographing smiles of a baby, the user can point the camera of the intelligent terminal to the baby and activates the capturing function of the present embodiment. The intelligent terminal activates corresponding functions according to an instruction for activating the capturing function of the present embodiment input by the user, obtains images of the baby in real time by the camera according to a preset frequency, generates preview images and displays the preview images on the display screen.

In step 320, human facial recognition and human facial focusing are performed.

The intelligent terminal performs human facial recognition to obtained preview images, and controls the camera to focus on human face with regard to preview images in which human face is recognized. The intelligent terminal recognizes a human face region, and can determine profiles of five sense organs based on the face region. The intelligent terminal can determine five-sense-organ characteristic values in real time according to profile information of five sense organs. For example, the intelligent terminal can determine a lip region according to the recognized human face region, then extracts a profile of lips through an image processing algorithm, and determines a lip motion characteristic value according to the profile of lips. The lip motion characteristic value includes a splitting degree and/or an opening degree of lips.

In step 330, a smile characteristic value of each preview frame is calculated.

The intelligent terminal can determine the smile characteristic value of the user according to the splitting degree and/or the opening degree of lips. Generally, weighting factors can be preset separately for the splitting degree and the opening degree including a splitting degree weighting factor m and an opening degree weighting factor n (0≦m≦1, 0≦n≦1, and m+n=1), and a smile characteristic value of each frame of the preview image is determined according to an expression: smile characteristic value=splitting degree*m+opening degree*n. For example, the splitting degree weighting factor is 80% and the opening degree weighting factor is 20%, then a expression for calculating smile characteristic value of a moment when people smiles may be: smile characteristic value=splitting degree*80%+opening degree*20%.

In step 340, it is judged whether the smile characteristic value is greater than a preset threshold. If the smile characteristic value is greater than the preset threshold, step 350 is executed; and, if the smile characteristic value is not greater than the preset threshold, step 330 is executed.

The preset threshold may be an empirical value of the smile characteristic value at a moment of beginning of smile. The empirical value of the smile characteristic value may be obtained by counting mass facial expressions when people smiles based on statistical principles. The smile characteristic value calculated according to the smile characteristic value calculating expression is compared with the preset threshold. If the smile characteristic value is greater than the preset threshold, step 350 is executed; and, if the smile characteristic value is less than the preset threshold, the method is returned to execute step 330.

In step 350, continuous shooting is activated to perform continuous shooting for 1 minute.

When determining that the smile characteristic value included in the current preview image is greater than the preset threshold, the intelligent terminal regards the current preview image as an initial image and performs continuous shooting to the shooting scene for 1 minute. For example, when determining that the smile characteristic value included in the current preview image is greater than the preset threshold, the intelligent terminal regards the current preview image showing smile expression of the baby as the initial image, and performs continuous shooting to the baby for 1 minute.

In step 360, smile characteristic values of continuously shot images are calculated.

The intelligent terminal performs human facial recognition on each of the continuously shot images captured by continuously shooting, obtains the profile of lips, and determines the splitting degree and opening degree of each frame of continuously shot images according to the profile of lips. The smile characteristic value of each frame of continuously shot images is determined based on the splitting degree and opening degree, utilizing the calculating expression of smile characteristic values.

In step 370, one photo having a maximum smile characteristic value is selected and saved.

The intelligent terminal compares smile characteristic values of the continuously shot images captured by continuously shooting, selects one frame of continuously shot image having a maximum smile characteristic value as the final image, saves the final image and deletes remaining continuously shot images.

In step 380, photographing is completed.

The intelligent terminal saves the final image so as to accomplish one time of photographing of a moment when people smiles. The user may select a thumbnail of the final image to view the saved final image. In addition, the user may further continue to perform shooting according to the photographing mode of the present embodiment. For example, the intelligent terminal saves the final image having a best smile characteristic value of the baby so as to accomplish one time of photographing of a moment when the baby smiles. Subsequently, the intelligent terminal detects a viewing instruction input by the user, quits from the photographing mode of the present embodiment according to the viewing instruction, and displays the final image obtained by photographing.

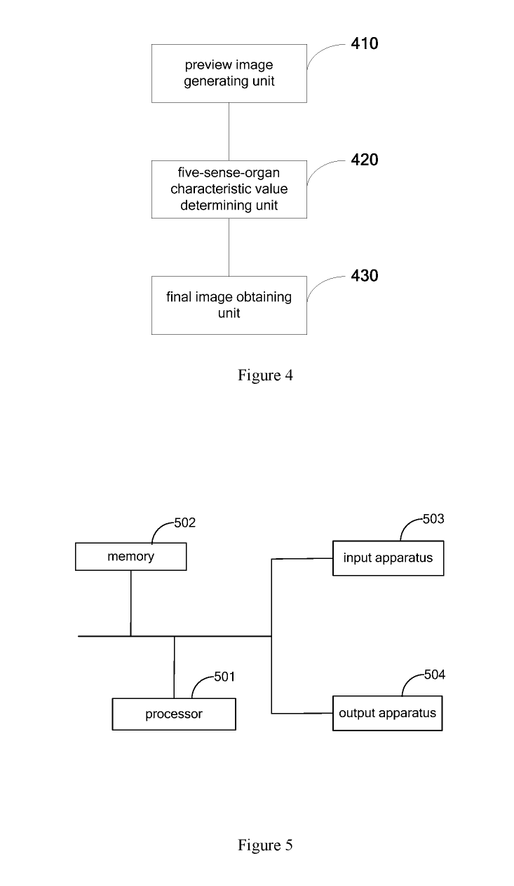

FIG. 4 is a schematic structural diagram illustrating a device for capturing photo according to embodiments of the present disclosure. The device for capturing photo includes a preview image generating unit 410, a five-sense-organ characteristic value determining unit 420 and a final image obtaining unit 430.

The preview image generating unit 410 is configured to obtain a shooting scene in real time by a camera so as to generate a preview image.

The five-sense-organ characteristic value determining unit 420 is configured to determine a five-sense-organ characteristic value of a human face image in each frame of the preview image.

The final image obtaining unit 430 is configured to photograph the shooting scene when the five-sense-organ characteristic value meets a set capturing condition, so as to obtain a final image.

According to technical solutions of the present embodiment, a shooting scene is obtained in real time by a camera using the preview image generating unit 410 so as to generate a preview image; a five-sense-organ characteristic value of a human face image in each frame of the preview image is determined by the five-sense-organ characteristic value determining unit 420; and the shooting scene is photographed using the final image obtaining unit 430 when the five-sense-organ characteristic value meets a set capturing condition, so as to obtain a final image. Technical solutions of the present embodiment solve a problem that a good opportunity for shooting is missed since a best moment for expressions of people is unable to foresee; achieve a purpose to automatically recognize expressions of people to shoot so as to obtain a photo with a best expression; and achieve effects of improving capturing efficiency and application experience of users.

Optionally, the final image obtaining unit 430 is configured to:
continuously shoot the shooting scene with a preset frame numbers of continuously shot images in a preset period of time, and determine an image having a maximum expression characteristic value in the continuously shot images as the final image.

Optionally, the five-sense-organ characteristic value determining unit 420 includes:

A lip motion characteristic value determining sub-unit, which is configured to determine a lip profile in each frame of the preview image which includes a human face, and determine a lip motion characteristic value according to the lip profile.

Optionally, the lip motion characteristic value determining sub-unit is configured to:
perform human facial recognition to each frame of the preview image, and perform focusing to a human face when the human face is recognized;
determine an approximate location of lips according to geometric features of the human face, and extract a lip profile after determining a precise location of lips according to the approximate location; and
determine a splitting degree and/or an opening degree of lips according to the lip profile.

Optionally, the device further includes:
a capturing condition determining unit, which is configured to compare the splitting degree with a preset first threshold after determining the splitting degree and/or the opening degree of lips according to the lip profile;
determine that the lip motion characteristic value meets the set capturing condition if the splitting degree is greater than the preset first threshold;
judge whether the opening degree is greater than a preset second threshold if the splitting degree is less than the preset first threshold;
determine that the lip motion characteristic value meets the set capturing condition when the opening degree is greater than the preset second threshold; and
determine that the lip motion characteristic value does not meet the set capturing condition when the opening degree is less than the preset second threshold.

Optionally, the final image obtaining unit 430 is configured to:
calculate a weighted sum of a splitting degree and an opening degree in each frame of image in the continuously shot images, so as to obtain an expression characteristic value; and
compare expression characteristic values of the continuously shot images, to determine a frame of image corresponding to a maximum expression characteristic value as the final image.

Optionally, the device further includes:
an image saving unit, which is configured to save the final image after the image having the maximum expression characteristic value in the continuously shot images is determined as the final image, and delete remaining images in the continuously shot images.

The aforementioned device for capturing photo can execute the method for capturing photo in any of embodiments of the present disclosure, and has corresponding function modules to execute the method and benefits.

FIG. 5 is a schematic diagram illustrating a hardware structure of an electronic device (such as a feature phone) provided by embodiments of the present disclosure. As illustrated in FIG. 5, the electronic device includes:

One or more processors 501 and a memory 502, where exemplified in FIG. 5 is one processor 501.

The electronic device may further include: an input apparatus 503 and an output apparatus 504.

The processor 501, the memory 502, the input apparatus 503 and the output apparatus 504 in the electronic device may be connected by a bus or by any other means, and exemplified in FIG. 5 is a bus connection.

The memory 502, a non-transitory computer readable storage medium, may be used to store a non-transitory software program, a non-transitory computer executable program and modules, such as program instructions/modules (for example, a preview image generating unit 410, a five-sense-organ characteristic value determining unit 420 and a final image obtaining unit 430 as shown in FIG. 4) corresponding to the method for processing image in the embodiments of the present disclosure. The processor 501 executes various functional applications of a server and data processing by running the nonvolatile software program, the instructions and the modules which are stored in the memory 502, that is, the method for capturing photo is realized.

The memory 502 may include a program storage area and a data storage area, where the program storage area may store an operating system, and applications required by at least one function; the data storage area may store data and the like created according to the use of the image white balance calibration method. In addition, the memory 502 may include a high-speed random access memory, and may further include a non-transitory memory. For example, at least one magnetic disk memory device, a flash device, or other nonvolatile solid-state memory devices. In some embodiments, the memory 502 optionally includes memories remotely disposed relative to the processor 501.

The input apparatus 503 may be used to receive input digital or character information, as well as a key signal input related to user settings and function control. The output apparatus 504 may include display devices such as a display screen.

The one or more modules are stored in the memory 502, and perform the method for capturing photo any of the above method embodiments when being executed by the one or more processors 501.

Embodiments of the present disclosure further provide a non-transitory storage medium, which stores a computer executable instruction, where the computer executable instruction is configured to perform the method for capturing photo in any one of the embodiments of the present disclosure.

The aforementioned product can execute the method provided by embodiments of the present disclosure, and be provided with corresponding function modules to execute the method and benefits. Regarding technical details not disclosed in detail, please referring to the process of capturing photo in any embodiment of the present disclosure.

The electronic device in embodiments of this disclosure exists in various forms, including but not limited to:
(1) mobile telecommunication device. A device of this kind has a feature of mobile communicating function, and has a main object of providing voice and data communication. Devices of this kind include smart phone (such as IPHONE), multi-media cell phone, functional cell phone, low-end cell phone and the like;
(2) ultra mobile personal computer device. A device of this kind belongs to a category of personal computer, has functions of calculating and processing, and generally has a feature of mobile interne access. Devices of this kind include PDA, MID, UMPC devices and the like, such as IPAD;
(3) portable entertainment device. A device of this kind can display and play multi-media content. Devices of this kind include audio and video player (such as IPOD), handheld game player, e-book, intelligent toy and portable vehicle navigation device;
(4) server, which is a device providing calculating services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;
(5) other electronic devices having data interacting functions.

Device embodiments described above are only illustrative, elements in the device embodiments illustrated as separated components may be or may not be physically separated, and components shown as elements may be or may not be physical elements, that is, the components may be located in one location, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or , in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make essential of corresponding technical solutions depart from spirits and scope of technical solutions of various embodiments.

What is claimed is:

1. A method for capturing photo, which is applied to an electronic device, comprising:
obtaining a shooting scene in real time by a camera so as to generate a preview image;
determining a five-sense-organ characteristic value of a human face image in each frame of the preview image; and
photographing the shooting scene when the five-sense-organ characteristic value meets a set capturing condition, so as to obtain a final image.

2. The method of claim 1, wherein the photographing the shooting scene so as to obtain a final image comprises:
shooting the shooting scene continuously with a preset frame numbers of continuously shot images in a preset period of time, and determining an image having a maximum expression characteristic value in the continuously shot images as the final image.

3. The method of claim 2, wherein the determining a five-sense-organ characteristic value of a human face image in each frame of the preview image comprises:
determining a lip profile in each frame of the preview image which includes a human face, and determining a lip motion characteristic value based on the lip profile.

4. The method of claim 3, wherein the determining a lip profile in each frame of the preview image which includes a human face, and determining a lip motion characteristic value based on the lip profile comprises:
performing human facial recognition to each frame of the preview image, and performing focusing to a human face when the human face is recognized,
determining an approximate location of lips according to geometric features of the human face, and extracting a lip profile after determining a precise location of lips according to the approximate location, and
determining a splitting degree and/or an opening degree of lips according to the lip profile.

5. The method of claim 4, wherein after determining the splitting degree and/or opening degree of lips according to the lip profile, further comprising:
comparing the splitting degree with a preset first threshold,
determining that the lip motion characteristic value meets the set capturing condition if the splitting degree is greater than the preset first threshold,
judging whether the opening degree is greater than a preset second threshold if the splitting degree is less than the preset first threshold,
determining that the lip motion characteristic value meets the set capturing condition when the opening degree is greater than the preset second threshold, and
determining that the lip motion characteristic value does not meet the set capturing condition when the opening degree is less than the preset second threshold.

6. The method of claim 4, wherein the determining an image having a maximum expression characteristic value in the continuously shot images as the final image comprises:
calculating a weighted sum of a splitting degree and an opening degree in each frame of image in the continuously shot images so as to obtain an expression characteristic value; and
comparing expression characteristic values of the continuously shot images, to determine a frame of image corresponding to a maximum expression characteristic value as the final image.

7. The method of claim 2, wherein after determining an image having a maximum expression characteristic value in the continuously shot images as the final image, further comprising:
saving the final image, and deleting remaining images in the continuously shot images.

8. An electronic device for capturing photo, comprising: at least one processor; and a memory communicably connected with the at least one processor for storing instructions executable by the at least one processor, wherein execution of the instructions by the at least one processor causes the at least one processor to perform:
obtaining a shooting scene in real time by a camera so as to generate a preview image;
determining a five-sense-organ characteristic value of a human face image in each frame of the preview image; and
photographing the shooting scene when the five-sense-organ characteristic value meets a set capturing condition, so as to obtain a final image.

9. The electronic device of claim 8, wherein when photographing the shooting scene so as to obtain a final image, the at least one processor performs:
shooting the shooting scene continuously with a preset frame numbers of continuously shot images in a preset period of time, and determining an image having a maximum expression characteristic value in the continuously shot images as the final image.

10. The electronic device of claim 9, wherein when determining a five-sense-organ characteristic value of a human face image in each frame of the preview image, the at least one processor performs:
determining a lip profile in each frame of the preview image which includes a human face, and determining a lip motion characteristic value based on the lip profile.

11. The electronic device of claim 10, wherein when determining a lip profile in each frame of the preview image which includes a human face, and determining a lip motion characteristic value based on the lip profile, the at least one processor performs:
performing human facial recognition to each frame of the preview image, and performing focusing to a human face when the human face is recognized,
determining an approximate location of lips according to geometric features of the human face, and extracting a lip profile after determining a precise location of lips according to the approximate location, and
determining a splitting degree and/or an opening degree of lips according to the lip profile.

12. The electronic device of claim 11, wherein execution of the instructions by the at least one processor causes the at least one processor to further perform:
comparing the splitting degree with a preset first threshold,
determining that the lip motion characteristic value meets the set capturing condition if the splitting degree is greater than the preset first threshold,
judging whether the opening degree is greater than a preset second threshold if the splitting degree is less than the preset first threshold,
determining that the lip motion characteristic value meets the set capturing condition when the opening degree is greater than the preset second threshold, and
determining that the lip motion characteristic value does not meet the set capturing condition when the opening degree is less than the preset second threshold.

13. The electronic device of claim 11, wherein when determining an image, having a maximum expression characteristic value, in the continuously shot images as the final image, the at least one processor performs:
calculating a weighted sum of a splitting degree and an opening degree in each frame of image in the continuously shot images so as to obtain an expression characteristic value; and
comparing expression characteristic values of the continuously shot images, to determine a frame of image corresponding to a maximum expression characteristic value as the final image.

14. The electronic device of claim 9, wherein execution of the instructions by the at least one processor causes the at least one processor to further perform:
saving the final image, and deleting remaining images in the continuously shot images.

15. A non-transitory computer-readable storage medium storing executable instructions that, when executed by an electronic device, cause the electronic device to perform:
obtaining a shooting scene in real time by a camera so as to generate a preview image;
determining a five-sense-organ characteristic value of a human face image in each frame of the preview image; and
photographing the shooting scene when the five-sense-organ characteristic value meets a set capturing condition, so as to obtain a final image.

16. The non-transitory computer-readable storage medium of claim 15, wherein when photographing the shooting scene so as to obtain a final image, the electronic device performs:
shooting the shooting scene continuously with a preset frame numbers of continuously shot images in a preset period of time, and determining an image having a maximum expression characteristic value in the continuously shot images as the final image.

17. The non-transitory computer-readable storage medium of claim 16, wherein when determining a five-sense-organ characteristic value of a human face image in each frame of the preview image, the electronic device performs:
determining a lip profile in each frame of the preview image which includes a human face, and determining a lip motion characteristic value based on the lip profile.

18. The non-transitory computer-readable storage medium of claim 17, wherein when determining a lip profile in each frame of the preview image which includes a human face, and determining a lip motion characteristic value based on the lip profile, the electronic device performs:
performing human facial recognition to each frame of the preview image, and performing focusing to a human face when the human face is recognized,
determining an approximate location of lips according to geometric features of the human face, and extracting a lip profile after determining a precise location of lips according to the approximate location, and
determining a splitting degree and/or an opening degree of lips according to the lip profile.

19. The non-transitory computer-readable storage medium of claim 15, wherein the electronic device further performs:
comparing the splitting degree with a preset first threshold,
determining that the lip motion characteristic value meets the set capturing condition if the splitting degree is greater than the preset first threshold,
judging whether the opening degree is greater than a preset second threshold if the splitting degree is less than the preset first threshold,
determining that the lip motion characteristic value meets the set capturing condition when the opening degree is greater than the preset second threshold, and
determining that the lip motion characteristic value does not meet the set capturing condition when the opening degree is less than the preset second threshold.
